(19) United States
(12) Patent Application Publication
(10) Pub. No.: US 2025/0213414 A1
(43) Pub. Date: Jul. 3, 2025

(54) KNEE EXTENSION STRETCH DEVICE

(71) Applicant: Eduardo Marti, Sunrise, FL (US)

(72) Inventor: Eduardo Marti, Sunrise, FL (US)

(21) Appl. No.: 18/396,851

(22) Filed: Dec. 27, 2023

(51) Int. Cl. A61H 1/02

(52) U.S. Cl. CPC A61H 1/024; A61H 2201/1284; A61H 2201/1621; A61H 2201/1642; A61H 2201/1676; A61H 2203/0437

(57) ABSTRACT

A knee extension stretch device operable to apply force which assists in extension of the knee joint of a user in a static progressive manner which includes a device body having an attached torso wrap. The device body is structured to run along a substantially straightened target leg that is positioned in front of a seated user, with the connected torso wrap extending from the device body and encircling the user's torso. The device body is structured to transfer the force created by the user leaning back into the torso wrap into force which acts on the leg of the user both above the knee and below the knee simultaneously to force extension of the knee. In this regard, the user is able to apply force which helps with knee extension, and control the amount of force applied, without needing to use their hands or arms.

### BACKGROUND OF THE INVENTION

### Field of the Invention

This invention relates generally to a leg stretching device and, more particularly, to a stretching device which allows a user to selectively apply static progressive force around the knee joint which causes an extension stretch to be experienced by the muscle and tissue of the knee area.

### Description of the Prior Art

An injury to, or a surgical procedure on, a limb and/or joint is typically followed by a period of rehabilitation in order to aid recovery. Post-operative rehabilitation of the joint has been shown to reduce the likelihood of scar tissue build up, reduced mobility and muscle atrophy. Joint rehabilitation further promotes faster healing, reduction of the amount of pain experienced, and improvement in the range of motion of the affected joint.

With respect to a knee joint, rehabilitation generally requires that the knee be flexed and the leg be extended; such as occurs in normal walking. Nonetheless, in many cases it may be undesirable for a recovering patient to frequently walk and bear weight on their leg in order to rehabilitate the knee. In addition, when their knee has suffered a trauma or other injury, or after surgery, a patient often lacks the necessary muscle control and strength to extend their knee and straighten their leg on their own. As such, at certain stages of the rehabilitation process for the knee, it is typical for the rehabilitation to require the assistance of a therapist or other person to help extend the knee and straighten leg of a patient.

Various forms of stretching are commonly employed to apply the desired flexing and extension movements in order to improve knee rehabilitation outcomes. Therapists commonly utilize the terms “passive,” “dynamic,” and “static-progressive” when discussing the three applicable modalities for causing, among other things, extension of the knee. A passive stretch is when a patient is placed into a machine that provides passive continuous motion to the knee so that the patient's knee moves within a comfortable area. This is typically used immediately following surgery to increase blood flow to the surgically repaired knee and help reduce swelling of the knee so that more advanced forms of rehabilitation of the knee can start.

Once the swelling has decreased and the next steps in rehabilitation are able to start, a physical therapist may have the patient engage in dynamic and/or static-progressive stretching. This is done so that the patient can regain full range of motion to their knee. These types of movements break down post operative scar tissue so as to prevent the “binding” or “locking up” of the knee due to excessive scar tissue. If scar tissue is not managed properly during rehab sessions it may lead to further complications which may require additional surgery, such as manipulation under anesthesia (“MUA”). With MUA, a patient is put asleep so that a surgeon can manually to break down the scar tissue that prevents knee from functioning properly.

Static progressive stretching techniques often involve the use of stretch devices operative to hold a joint in a set position but allow for progressive modification of the joint angle. In many instances, devices or other implements may be used as a part of static progressive stretching. A limitation which still exists for such static progressive stretch devices, however, is that they typically require the patient, or some other person, to manually hold the device in place to hold the joint in a set position or to manually move the device to cause the progressive modification of the joint angle.

Thus, there remains a need for a knee extension stretch device which allows for static-progressive force to be applied at a knee joint of a user without requiring the assistance of an additional person. It would be additionally desirable for such a knee extension stretch device to enable a user to directly exert force to manually move the device in a manner which causes the progressive modification of the joint angle without the use of their arms or hands.

### SUMMARY OF THE INVENTION

The present disclosure provides for a knee extension stretch device, comprising: a device body having an extension section, wherein the device body is configured to be positioned adjacent to the substantially straightened leg of a seated human user with the extension section structured to contour to the substantially straightened leg; wherein when the device body is positioned adjacent to the substantially straightened leg, the extension section includes a thigh support which is located over the thigh of the substantially straightened leg and an ankle support which is located over the ankle of the substantially straightened leg; a force application member, or torso wrap, connected to the device body, wherein the force application member is configured to extend around the user's torso; and wherein when the device body is positioned adjacent to the substantially straightened leg and the force application member is positioned around the user's torso, movement of the user's torso away from the device body simultaneously causes downward force to be exerted through the thigh support into the substantially straightened leg and upward force to be exerted through the ankle support into the substantially straightened leg.

The device body may additionally include a discrete lever section and a discrete distal section, each of which extends out from the extension section and is otherwise structured to translate force from the movement of the user's torso away from the device body to forces which cause downward force to be exerted through the thigh support and upward force to be exerted through the ankle support.

It is an object of the present disclosure to provide a knee extension stretch device which allows for static-progressive force to be applied at a knee joint of a user without requiring the assistance of an additional person.

It is an additional object of the present disclosure to provide a knee extension stretch device which enables a user to exert force to manually move the device in a manner which causes the progressive modification of the joint angle without the use of their arms or hands.

### BRIEF DESCRIPTION OF THE DRAWINGS

FIG. 1 is a side perspective view of a knee extension stretch device built in accordance with the present invention, shown in place on a user.

FIG. 2 is a side perspective view of a knee extension stretch device built in accordance with the present invention.

FIG. 3 is a side elevational view of a knee extension stretch device built in accordance with the present invention.

FIG. 4 is a top plan view of a knee extension stretch device built in accordance with the present invention.

FIG. 5 is a side perspective view of a knee extension stretch device built in accordance with the present invention with the torso wrap removed.

FIG. 6 is a side perspective view of a torso wrap of a knee extension stretch device built in accordance with the present invention.

FIG. 7 is an exploded side perspective view of a lever section of a knee extension stretch device built in accordance with the present invention with the torso wrap removed.

FIG. 8 is an exploded side perspective view of an upper portion of an extension section of a knee extension stretch device built in accordance with the present invention.

FIG. 9 is an exploded side perspective view of the lower portion of the extension section and a distal section of a knee extension stretch device built in accordance with the present invention.

### DETAILED DESCRIPTION OF THE INVENTION

Described herein is a knee extension stretch device operable to apply force which assists in extension of the knee joint of a user in a static progressive manner. The knee extension stretch device includes a rigid device body to which a torso wrap (or thoracic wrap) is attached, and is constructed to allow the device body to run along a target leg that is positioned in front of a user, with the connected torso wrap extending from the device body and encircling the user's torso. The device body is structured to transfer the force created by the user leaning back into the torso wrap into force which acts on the leg of the user in several locations simultaneously to produce extension of the knee.

Through this design and alignment, a user in a non-supine (i.e., seated) position can selectively lean back into the torso wrap and thereby cause the device body to apply force on the target knee which causes controlled extension of the knee. In this regard, the user is able to control the amount of force applied at all times without needing to use their hands or arms. The nature of the user's position when operating the knee extension stretch device provides for comfortable and independent usage of the device, and the nature of the device provides for usage which is suitable for users with back or mobility issues and for those lacking sufficient arm strength.

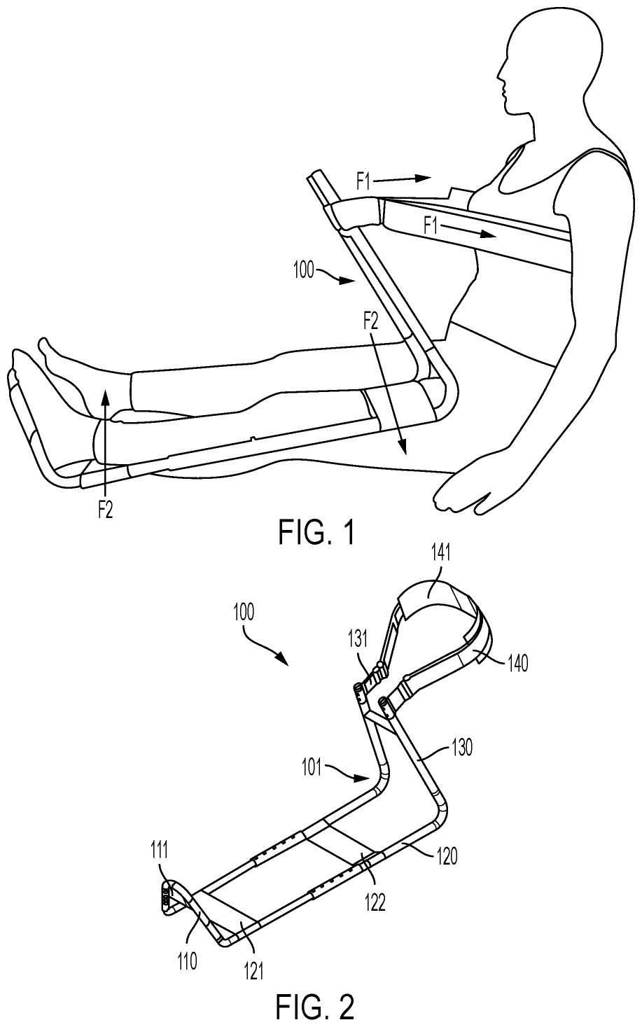

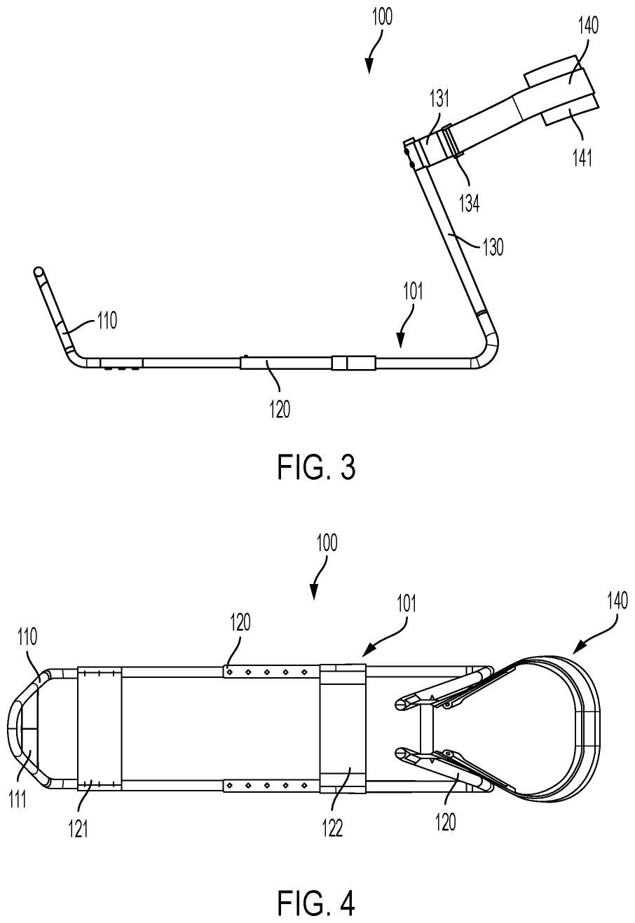

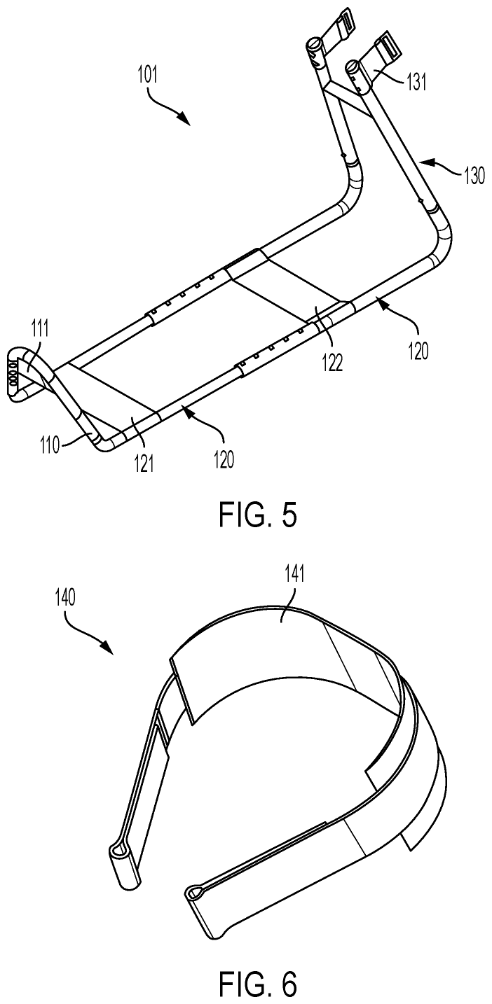

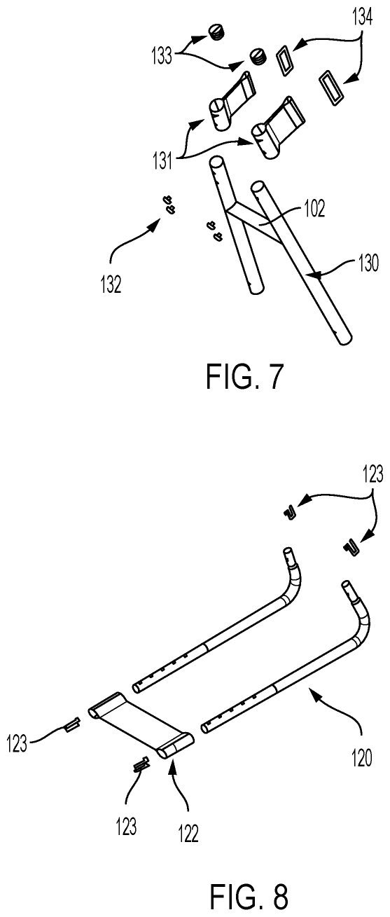

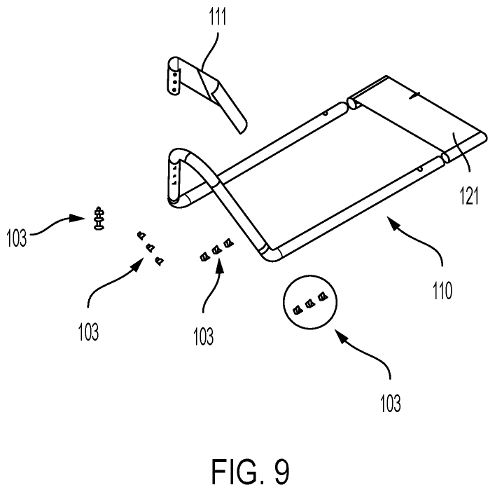

Referring now to the drawings and, in particular, FIGS. 1, 2, 3, 4, 5, 6, 7, 8 and 9, a knee extension stretch device 100 may include a device body 101 having of two strut members shaped to contour to a leg on each side, formed in such a way as to allow for a mechanical force to be leveraged at one end of the strut members to exert extension pressure on a knee joint of a leg positioned between the strut members. The knee extension stretch device 100 additionally may include a torso wrap 140 which enables the extension stretching force to be applied without the use of a user's hands or arms, but rather through the weight of the user's torso/upper body. As such, the torso wrap 140 removes the need for a user to manually apply pressure with their hands to force the device body 101 in a manner that extends the knee. Instead, by leaning back on the torso wrap 140, the force to cause extension of the knee is automatically applied through the movement of the device body 101. Increased application of force to extend (i.e. straighten) the knee can further be accomplished by leaning back further on the torso wrap 140. This advantageous feature is especially important to users who may be senior citizens or otherwise may lack arm strength to apply constant downward pressure on a frame to extend the knee joint.

The strut members, of which two may be used, are formed of a rigid material, such as aluminum. They generally run in parallel and longitudinally, may be constituted of several strut sections which operate together to supply support and leverage. These sections include a distal section 110, which includes a foot support 111, an extension section 120, which may include an ankle support 121 and a thigh support 122, and a lever section 130. The foot support 111, the ankle support 121, and the thigh support 122 may each be constructed of support members, which may be defined as discrete, fixedly attached bands, slidably adjustable bands, or adjustably secured pressure pads that contour the shape of the leg. The foot support 111, the ankle support 121, and the thigh support 122 extend between the two parallel strut members, and thus these items may be integrated through the use of the foot support 111, the ankle support 121, and the thigh support 122. In some embodiments, the foot support 111 may be attached to the device body 101 through the use of mounting studs 103 and the ankle support 121 and the thigh support 122 may be slidably disposed on the device body 101.

In the distal section 110, the strut members curve in such a way as to contour the position of a flexed foot of a leg that is being used with the knee extension stretch device 100. In addition, the strut members may come together to a distal end point in the distal section 110 in order to provide the device body 101 with rigidity. The strut members, however, do not come together in the lever section 130. Instead, the device body 101 may additionally include a structural support member 102 formed of the same material as the strut members themselves which extends between the strut members in the lever section 130 and is configured to resist forces which would push the two struts towards each other and thereby maintain the structural stability of the lever section 130 of the device body 101. It is contemplated that locating the structural support member 102 further down away from the end of the lever section (where the torso wrap attaches) better resists forces which would push the two struts towards each other than if the strut members merely came together in the lever section 130 like they do in the distal section 110.

The extension section 120 may be configured to be length adjustable through the use of an upper extension segment which is structured to connect to the lever section and a lower extension segment which is structured to form a lower portion of the extension section 120 as well as the distal section 110, with the lower extension segment sized to be telescopically inserted into the upper extension segment and selectively locked in place at various points through an engagement of spring loaded adjustment pins 123 which are coupled with the lower extension segment and correspond to apertures on the surface of the upper extension segment.

In some embodiments, the lever section 130 may be removably attachable to the upper extension segment through the use of spring loaded adjustment pins 123 which are coupled with the upper extension segment and correspond to apertures on the surface of the lever section 130.

The lever section 130 is configured to allow for the attachment of the torso wrap 140 through the use of a pair of wrap connectors 131 which are each attached adjacent to an end of one strut member in the lever section 130. The wrap connectors 131 may each include a clamp which is sized to receive and releasably hold an end of the torso wrap 140. The wrap connectors 131 may be fixed to the device body using lever mounting studs 132. In addition, an end cap 133 may be employed at the end of each strut member.

The torso wrap 140 may be formed from a nylon webbing strap base, and may include a pad element 141 which is wider than the strap base. It is contemplated that the pad element 141 may provide a more comfortable object for a user to lean their back into relative to the strap base.

When attached to the lever section, one or a pair of adjustment buckles 134 may be coupled with the torso wrap 140 to allow the functional length of the torso wrap 140, and thus the size of the loop it forms, to be adjusted.

In use, when the knee extension stretch device 100 is fitted to a user, as illustrated in FIG. 1, the user may assume a seated position (non-supine) and the device may be fitted to the leg which requires rehabilitation. The knee extension stretch device 100 may be orientated such that the lever section 130 is closer to the user's torso and the distal section 110 is oriented toward the foot of the user. The thigh support 122 is placed on top of their thigh while the ankle support 121 is placed beneath their ankle. Their foot is positioned on top of the foot support 111. The torso wrap 140, which is attached to the end of the lever section 130, may be wrapped around the back of the user. In this arrangement, as the user leans back into the wrap, forces are applied at the end of the lever section 130 by way of the torso wrap 140 are transferred downward through the thigh support 122 and upward through the ankle support 121, as indicated by the arrows designated F1. These forces result in an extension stretch being experienced by the posterior chain of the leg and knee area, as indicated by the arrows designated F2.

In this regard, the knee extension stretch device 100 allows for static-progressive stretching of the knee joint. This type of therapy treatment has been clinically proven to help restore full range of motion to the knee by breaking down scar tissue which oftentimes binds the knee joint following surgery and inhibits full range of motion. The knee extension stretch device 100, thru its torso wrap 140, allows for home based “hands-off” static-progressive therapy. The ability to perform static-progressive stretches with a hands-off approach is critical. Studies have shown that it is virtually impossible for anyone to “press down” on any type of knee stretching device with their arms/hands and hold the stretch in that same spot for extended periods of time. Thus, devices which rely on the use of arms/hands to accomplish this typically deliver unsatisfactory results. The ability to maintain consistency of position with the stretch-hold is paramount. Too much stretching can cause too much pain, and may set someone back in their recovery, and too little knee stretch does not break down the scar tissue, which may lead to a poor recovery. The knee extension stretch device's 100 ability to stretch the knee joint in a controlled and reproducible manner will allow for optimal outcomes.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A knee extension stretch device, comprising:
a device body having an extension section, wherein the device body is configured to be positioned adjacent to the substantially straightened leg of a seated human user with the extension section structured to contour to the substantially straightened leg;
wherein when the device body is positioned adjacent to the substantially straightened leg, the extension section includes a first support which is located over a first position of the substantially straightened leg which is higher than the knee and a second support which is located over a second position of the substantially straightened leg which is lower than the knee;
a force application member connected to the device body, wherein the force application member is configured to extend around the user's torso; and
wherein when the device body is positioned adjacent to the substantially straightened leg and the force application member is positioned around the user's torso, movement of the user's torso away from the device body simultaneously causes downward force to be exerted through the first support into the substantially straightened leg and upward force to be exerted through the second support into the substantially straightened leg.

2. The knee extension stretch device of claim 1, wherein:
the device body additionally includes a lever section, wherein when the device body is positioned adjacent to the substantially straightened leg, the lever section is adjacent to the user's torso; and
the force application member connected to the lever section.

3. The knee extension stretch device of claim 2, wherein the force application member is defined by a torso wrap which is structured to wrap around the user's torso.

4. The knee extension stretch device of claim 1, wherein the force application member is defined by a torso wrap which is structured to wrap around the user's torso.

5. The knee extension stretch device of claim 1, wherein the device body additionally includes a distal section, wherein when the device body is positioned adjacent to the substantially straightened leg, the distal section is adjacent to the user's foot.

6. The knee extension stretch device of claim 5, wherein the extension section and the distal section are each substantially linear, and between the extension section and the distal section, the device body curves such that the distal section is oriented at an obtuse angle relative to the extension section.

7. The knee extension stretch device of claim 5, wherein the extension section and the distal section are each substantially linear, and between the extension section and the distal section, the device body curves to contour the position of the flexed foot of the substantially straightened leg.

8. The knee extension stretch device of claim 5, wherein the distal section includes a foot support.

9. The knee extension stretch device of claim 1, wherein the first support is defined as a thigh support and the first position of the substantially straightened leg defines the thigh.

10. The knee extension stretch device of claim 1, wherein the second support is defined as an ankle support and the second position of the substantially straightened leg defines the ankle.

11. The knee extension stretch device of claim 1, wherein the extension section and the lever section are each substantially linear, and between the extension section and the lever section, the device body curves such that the lever section is oriented at an acute angle relative to the extension section.

12. The knee extension stretch device of claim 11, additionally comprising a support member integral with the lever section, wherein the support member is configured to maintain the structural stability of the lever section of the device body when there is movement of the user's torso away from the device body in the force application member.

13. The knee extension stretch device of claim 1, wherein the extension member is configured to be selectively lengthened and shortened.

14. A knee extension stretch device, comprising:
a device body having an extension section, lever section, and distal section, wherein the device body is configured to be positioned adjacent to the substantially straightened leg of a seated human user with the extension section structured to contour to the substantially straightened leg, and when the device body is positioned adjacent to the substantially straightened leg, the lever section is adjacent to the user's torso and the distal section is adjacent to the user's foot;
wherein when the device body is positioned adjacent to the substantially straightened leg, the extension section includes a first support which is located over a first position of the substantially straightened leg which is higher than the knee and a second support which is located over a second position of the substantially straightened leg which is lower than the knee;
a force application member connected to the lever section, wherein the force application member is configured to extend around the user's torso; and
wherein when the device body is positioned adjacent to the substantially straightened leg and the force application member is positioned around the user's torso, movement of the user's torso away from the device body simultaneously causes downward force to be exerted through the first support into the substantially straightened leg and upward force to be exerted through the second support into the substantially straightened leg.

15. The knee extension stretch device of claim 14, additionally comprising a support member integral with the lever section, wherein the support member is configured to maintain the structural stability of the lever section of the device body when there is movement of the user's torso away from the device body in the force application member.

16. The knee extension stretch device of claim 14, wherein the extension section and the lever section are each substantially linear, and between the extension section and the lever section, the device body curves such that the lever section is oriented at an acute angle relative to the extension section.

17. The knee extension stretch device of claim 16, wherein the extension section and the distal section are each substantially linear, and between the extension section and the distal section, the device body curves such that the distal section is oriented at an obtuse angle relative to the extension section.

18. The knee extension stretch device of claim 14, wherein the force application member is defined by a torso wrap which is structured to wrap around the user's torso.

19. The knee extension stretch device of claim 14, wherein:
the distal section includes a foot support;
the first support is defined as a thigh support and the first position of the substantially straightened leg defines the thigh; and
the second support is defined as an ankle support and the second position of the substantially straightened leg defines the ankle.

20. A knee extension stretch device, comprising:
a device body having an extension section, lever section, and distal section, wherein the device body is configured to be positioned adjacent to the substantially straightened leg of a seated human user with the extension section structured to contour to the substantially straightened leg, and when the device body is positioned adjacent to the substantially straightened leg, the lever section is adjacent to the user's torso and the distal section is adjacent to the user's foot;
wherein when the device body is positioned adjacent to the substantially straightened leg, the extension section includes a thigh support which is located over the thigh of the substantially straightened leg and an ankle support which is located over the ankle of the substantially straightened leg;
a force application member connected to the lever section, wherein the force application member is configured to extend around the user's torso;
wherein when the device body is positioned adjacent to the substantially straightened leg and the force application member is positioned around the user's torso, movement of the user's torso away from the device body simultaneously causes downward force to be exerted through the thigh support into the substantially straightened leg and upward force to be exerted through the ankle support into the substantially straightened leg;
wherein the force application member is defined by a torso wrap which is structured to wrap around the user's torso;
a support member integral with the lever section, wherein the support member is configured to maintain the structural stability of the lever section of the device body when there is movement of the user's torso away from the device body in the force application member; and
wherein the distal section includes a foot support.
